(19) United States
(12) Patent Application Publication
(10) Pub. No.: US 2021/0006835 A1
(43) Pub. Date: Jan. 7, 2021

(54) BLURRING TO IMPROVE VISUAL QUALITY IN AN AREA OF INTEREST IN A FRAME

(71) Applicant: Microsoft Technology Licensing, LLC, Redmond, WA (US)

(72) Inventors: Kathleen Anne SLATTERY, Seattle, WA (US); Saswata MANDAL, Redmond, WA (US); Daniel Gilbert KENNETT, Bellevue, WA (US)

(73) Assignee: Microsoft Technology Licensing, LLC, Redmond, WA (US)

(21) Appl. No.: 16/458,824

(22) Filed: Jul. 1, 2019

(51) Int. Cl. H04N 19/60; H04N 19/30; G06N 20/00; G06K 9/00

(52) U.S. Cl. CPC H04N 19/60; G06K 9/00744; G06N 20/00; H04N 19/30

(57) ABSTRACT

A system and method for utilizing machine learning techniques to modify a visual quality of an area within a frame of video is provided. The method may include receiving one or more video frames of a video stream, receiving a target asset and generating, via a machine learning model, a frame mask identifying an area within the one or more video frames of the video stream that is associated with the target asset, and then modifying a visual quality of the identified area within the one or more video frames based on the frame mask. In some instances, techniques other than or in addition to machine learning techniques may be utilized. For example, template matching techniques may also be used to identify one or more areas for modifying a visual quality.

### BACKGROUND

Quality of distributed video streams including gaming video streams tend to be limited by bit rate and/or bandwidth sizes. More specifically, in instances where a bit rate budget is not large enough, the quality of an entire frame or plurality of frames may suffer. That is, an entire frame or video may need to under go changes in order to comply with transmission limitations imposed by networks and devices. For example, a resolution of streaming video may be limited; in order to comply with bit rate and/or bandwidth restrictions, the resolution of the entire video may be reduced. Reducing the video resolution but keeping the bit rate the same will result in better encoded video quality but at a loss of visual resolution, such as the loss of fine detail. The reduction in visual resolution may cause a user to shy away or stop using a service.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure are generally directed to frame and/or pixel analysis techniques that identify target assets for one or more pre-encoding operations that may assist in maintaining a desired bit rate at an encoder, where such operations may include, but are not limited to blurring operations and/or enhancement operations. The frame or pixel analysis may be based on factors that help user's eyes visually distinguish areas of interest (or non-interest) within a frame, such as small features, patterns, or text. Machine learning capabilities may be utilized in such examples to perform ongoing frame and or pixel analysis. Based on the analysis, one or more target assets may not be blurred when other non-interest areas of the frame are blurred. In some instances, techniques other than machine learning techniques, such as but not limited to template matching techniques, may also be used in conjunction with machine learning techniques to identify one or more areas of interest. In some instances, a mask may be generated for operating on critical areas of the frame, where the frame may be one or more frames in a stream, such as a stream of game content. The mask may be generated by a game or title on a frame-by-frame basis, for instance. In some examples, the compositing mask may be commonly used when combining the user interface to the rendered game frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a streaming content distribution system in accordance with the aspects of the disclosure;

FIG. 2 depicts details of pre-encoder frame analyzer and quality analyzer in accordance with examples of the present disclosure;

FIG. 3 depicts details of a region of non-interest identification and subsequent blurring in accordance with examples of the present disclosure;

FIG. 4 depicts details directed to a mask generation that identifies regions of interest and provides an enhancement operation in accordance with examples of the present disclosure;

FIG. 5 depicts details directed to a mask generation that identifies regions of interest and provides enhancement and blurring operations in accordance with examples of the present disclosure;

FIG. 6 depicts additional details directed to target asset generation in accordance with examples of the present disclosure;

FIG. 7 depicts additional details directed to area of interest/non-interest identification, blurring/enhancement operation, and quality analysis in accordance with examples of the present disclosure;

FIG. 8 depicts first and second data structures in accordance with examples of the present disclosure;

FIG. 9 depicts a first method in accordance with examples of the present disclosure;

FIG. 10 depicts a second method in accordance with examples of the present disclosure;

FIG. 11 depicts a block diagram illustrating example physical components of a computing device with which aspects of the disclosure may be practiced;

FIG. 12A depicts a simplified block diagram of a computing device with which aspects of the present disclosure may be practiced;

FIG. 12B depicts another simplified block diagram of a mobile computing device with which aspects of the present disclosure may be practiced; and

FIG. 13 depicts a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

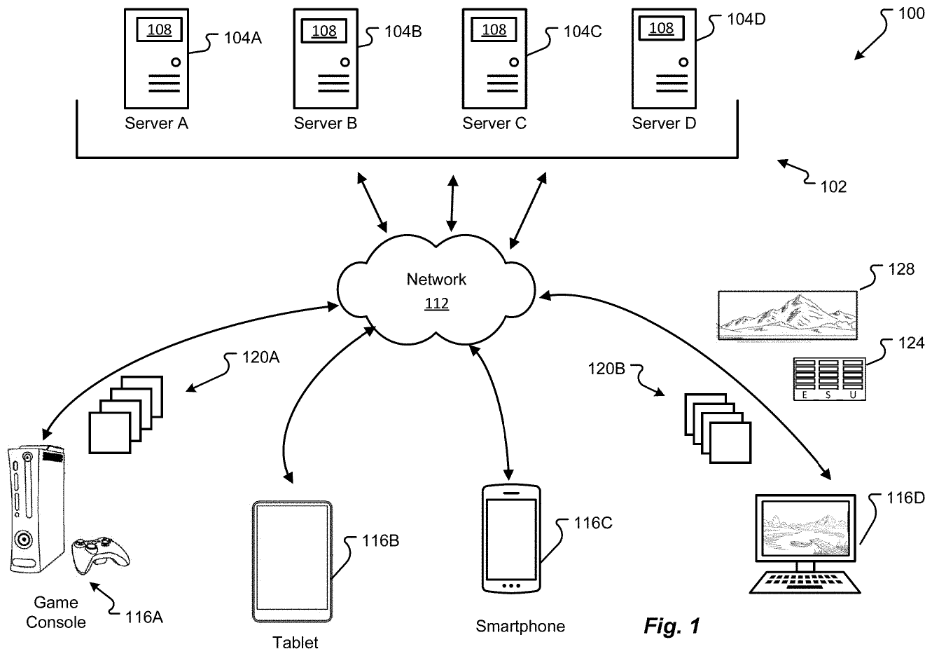

FIG. 1 depicts a system directed to the distribution of video content, such as streamed video and/or streamed game content, in accordance with examples of the present disclosure. More specifically, a streaming content distribution system 100, may be provided as illustrated in FIG. 1. The streaming content distribution system 100 may generally include one or more content providers 102. The one or more content providers 102 may include one or more game servers 104A-104D. Each of the game servers 104A-104D may include a game, or title, interface component 108 configured to provide video content, such as one or more frames of video or game content 120A/120B, to a target system via the network 112. The one or more frames of video or game content 120A-120B may generally represent compressed video content, such as streaming video content originating from one or more game servers 104A-104D. In accordance with examples of the present disclosure, the one or more frames of video or game content 120A-120B may be provided via the network 112 to one or more endpoints, also referred to as a user device and/or a client devices 116A-D. One or more client devices 116A-116D may receive the one or more frames of video or game content 120A-120B and cause the one or more frames of video or game content 120A-120B to be decoded and rendered to a display. In some examples, the client device 116A-116D may correspond to a game console 116A, a tablet device 116B, a smartphone 116C and/or a tablet 116D. In some instances, the endpoint may correspond to a server device that runs a session or otherwise interfaces with the game or title and causes the one or more frames of video or game content 120A-120B to be displayed at a display device. As another non-limiting example, at least one client device 116A-116D may be any device configured to allow a user to use an application such as, for example, a smartphone, a tablet computer, a desktop computer, laptop computer device, gaming devices, media devices, smart televisions, multimedia cable/television boxes, smart phone accessory devices, industrial machinery, home appliances, thermostats, tablet accessory devices, personal digital assistants (PDAs), or other Internet of Things (IOT) devices.

As can be appreciated, the one or more frames of video or game content 120A-120B may be limited, in some manner, by an amount of available bandwidth, or a bit rate, between one or more of the client devices 116A-116D and the one or more game servers 104A-104D. While encoding methods exist to compress video content prior to distribution and according to one or more compression standards, additional preprocessing applied to one or more frames of video or game content to reduce an amount of information required to represent small features, patterns, or text for example, may enable the encoder to further compress the one or more frames of video or game content. For example, by reducing a bit depth associated with an area of non-interest, an encoder may provide the one or more frames of video or game content 120A-120B in a format that requires less bandwidth or is otherwise reduced in size. Alternatively, or in addition, to help eyes visually distinguish areas of interest form areas of non-interest within a frame, one or more enhancement operations may be applied to small features, patterns, or text in an area of interest. Accordingly, the area of interest may include more detail, or otherwise appear to be more visually distinguishable from areas of non-interest. Moreover, a first stream, such as one or more frames of video or game content 120A, may be tailored specific to a first device, such as the game console 116A, while a second stream 120B, may be tailored specific to a second device, such as the client device 116D.

The additional preprocessing techniques applied to one or more frames of video or game content may be directed to one or more of blurring areas of non-interest and/or enhancing areas of interest. For example, as depicted in FIG. 1, a target asset 124, such as a portion of a heads up display, may be identified as an area of interest and may be enhanced. The heads up display levels associated with one or more characteristics of a character in a game for example. In some examples, a target asset 128 may specify an area of non-interest, such as the distant background, which may be identified as such and may be blurred. The blurring of the area of non-interest prior to being provided to an encoder, may allow the encoder to more efficiently compress the one or more frames of video, or game content, as the effect of blurring may reduce an amount of data, or information, needed to represent the target asset 128.

In some instances, the target asset 124 for enhancing and/or the target asset 128 for blurring may be identified by performing one or more frame and or pixel analysis techniques. In some instances, the target asset 124 and/or the target asset 128 may be identified utilizing one or more machine learning methods; the one or more machine learning methods may be utilized to generate a mask which may be used blur or enhance portions of a frame based on the provided mask. Alternatively, or in addition, one or more administrative tools, in a toolkit for example, may be utilized by a user or a game developer to provide, or otherwise identify, a target asset for blurring or enhancement. For example, the administrative tools may specifically operate on the target asset 124 and provide a representation of the target asset 124 as processed data to one or more machine learning models. The one or more machine learning models may utilize the processed data to determine and identify entities in one or more frames of video and/or game content corresponding to the target asset. Since one or more machine learning models may be utilized, the machine learning model may identify entities resembling the target asset 124 and/or the target asset 128 even though the entities within the frame may be scaled, translated, rotated, or otherwise appear as being different than the target asset 124 and/or target asset 128. As one example, as a game character moves in and out of a frame, one or more heads up displays associated with the game character may be identified as an entity based on the target asset 124 and therefore may be enhanced such that a user's eyes are able to more easily visually distinguish information displayed within the heads up display from other content in the frame. In some instances, the identified entity may be enhanced, such that a contrast between the identified entity corresponding to the target asset 124 and the rest of the content in the frame is increased.

As further depicted in FIG. 1, a machine learning model may operate on the target asset 128; the target asset 128 may correspond to a portion of a scenery, such as a portion of the scenery visually depicting an area that is distant from a user or player. In some instances, fine details or other small features, patterns, or text may not be important or are otherwise not where a user's focus should be directed. For example, the text on a billboard appearing to be located a great distance from the user may not be important. As another example, details of trees, mountains, or other landscape objects may not be important when such objects appears in the background and not the foreground. Accordingly, a machine learning model may identify distant areas, such as those areas similar to or otherwise matching the target asset 128, as areas of non-interest. Alternatively, or in addition, depth information may be provided by a game in the form of the game's own depth buffer, or a depth buffer generated by the game. Accordingly, the machine learning model may create a mask, based on the objects identified as appearing in the background and/or the depth information provided by the game, to provide to the encoder indicating that the areas of non-interest may be blurred and areas of interest that may be enhanced, thereby potentially reducing a bit rate associated with encoding that portion of the frame and/or enhancing a visual quality of a portion of the frame. In that the machine learning model may be utilized to identify translated, rotated, scaled, or otherwise transformed entities corresponding to the target asset 128, an explicit identification of the areas within each frame on a frame by frame basis generally provided by a game developer is not needed, thereby saving a considerable amount of work on behalf of the developer.

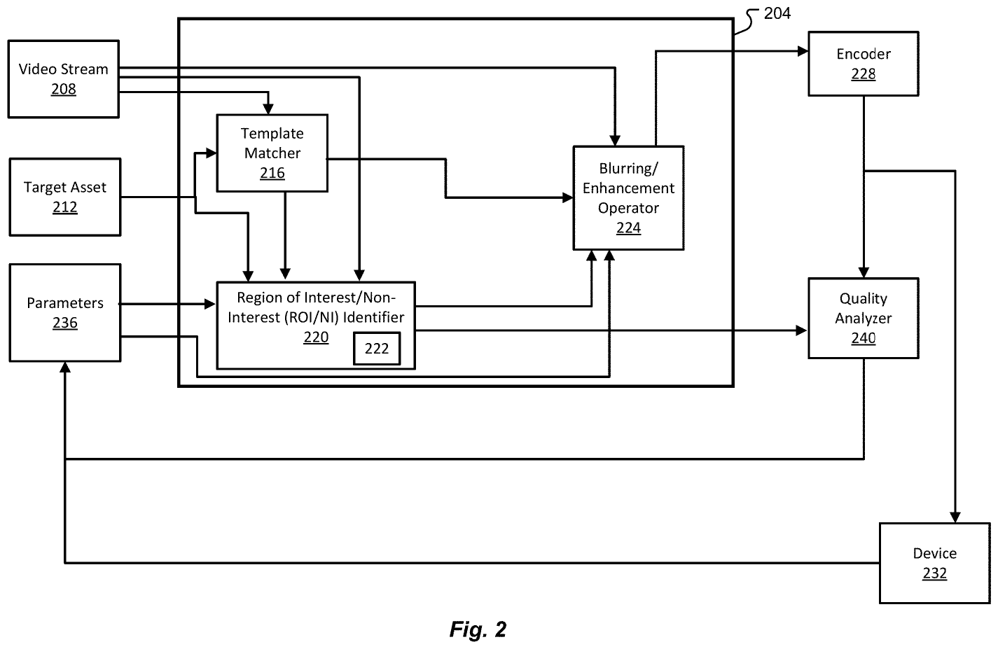

FIG. 2 depicts details of a block diagram of a pre-encoder frame analyzer 204 in accordance with examples of the present disclosure. More specifically, the pre-encoder frame analyzer 204 may include a template matcher 216, a region of interest or non-interest (ROI/NI) identifier 220, and a blurring/enhancement operator 224. In some instances, a video stream 208, such as a video streaming including one or more frames of video or game content, may be provided to the pre-encoder frame analyzer 204. The template matcher 216 may attempt to identify one or more regions of interest or regions of non-interest in each of the frames of the video stream 208 corresponding to a received target asset 212 based on template matching methods and techniques. For example, common template matching methods may be employed based on one or more pixel values in the target asset 212 that is matched to an entity in the frame. In some instances, a fast template matching may be achieved through normalized cross-correlation. Alternatively, or in addition, a squared difference matching technique and/or a standard squared difference matching technique may also be used. In some instances, algorithms based on a sum of absolute differences (SAD), sum of squared differences (SSD), normal correlation, joint entropy, maximum likelihood, and/or hamming distances may be utilized to identify pixels in a frame that are similar to the target asset 212 and/or a template based on the target asset 212. The template matcher 216 may then generate a mask that is applied to the specific frame, where the mask identifies one or more regions of non-interest that may be blurred and/or one or more regions of interest that may be enhanced by the blurring/enhancement operator 224. Although the template matcher 216 may identify the regions of interest or regions of non-interest in a mask, the blurring/enhancement operator 224 may not apply such operations if, for example, a quality of a resulting encoded frame is poor and/or an amount of bandwidth is increased.

As further depicted in FIG. 2, the template matcher 216 may provide the location and/or area of the frame to the region of interest or non-interest (ROI/NI) identifier 220. In some instances, the target asset 212 may be provided to the ROI/NI identifier 220; the ROI/NI identifier 220 may take one or more of the location and/or areas of the frame identified by the template matcher 216 and/or the target asset 212 and generate a mask. The mask generated by the ROI/NI identifier 220 may be based on one or machine learning models 222. For example, the machine learning model 222 may receive the target asset 212 and identify one or more entities within each frame of the video stream 208 for enhancing and/or blurring. As previously discussed, the one or more machine learning models may be utilized to identify entities resembling the target asset 212 even though entities may be scaled, translated, rotated, or otherwise appear as being different than the target asset 212. In some instances, a mask may be based on the identified entities and correspond to areas of interest and areas of non-interest, where the mask is then provided to the blurring/enhancement operator 224. In some instances, the machine learning model 222 may be utilized to identify areas of non-interest, such as distant scenery, slow moving objects, or other areas of the frame that may be deemed not to be of lower visual value such that displaying a high level of detail is not required.

As previously discussed, while the ROI/NI identifier 220 may provide the mask to the blurring/enhancement operator 224, the blurring/enhancement operator 224 may not necessarily apply such blurring and/or enhancements in instances where a bit rate required by the enhancements is greater than a bit rate available to the encoder 228. Moreover, the blurring/enhancement operator 224 may not necessarily apply such blurring and/or enhancements in instances where a quality of a displayed frame is degraded beyond that which is acceptable. For example, one or more parameters 236 corresponding to device characteristics and/or transmission characteristics may be received at the blurring/enhancement operator 224. The one or more parameters 236 may indicate an amount of bandwidth available, or otherwise an encoder bit rate budget. Thus, for example, the parameters 236 may be received from or otherwise derived from the device 232, where the device 232 may be the same as or similar to the client devices 116A-116D previously described. The parameters 236 may also indicate a type of device 232, such as a mobile device desktop device, gaming console, etc. and/or other identifying characteristics associated with the device 232. As another example, a firmware version, hardware type and/or version, and/or one or more enabled rendering parameters may be received as the parameters 236 from the device 232. Thus, for example, for devices that may support one or more post processing operations, the blurring and/or enhancement operations of one or more video frames, or game content, may be tailored to the device such that when decoded and rendered, the video stream 208 meets or exceeds a desired quality.

The ROI/NI identifier 220 may rely on one or more of the parameters 236 when determining, or generating, a mask based on a target asset 212. For example, a level of blurring may be based on one or more post-processing techniques enabled at the device 232. In some instances, the parameters 236 may indicate that the device 232 produces optimal rendered or otherwise displayed content when a blurring is of a certain amount and/or technique and/or an enhancement feature, such as contrast, is at a certain level. Accordingly, the parameters 236 may be provided to the blurring/enhancement operator 224 such that the blurring/enhancement operator 224 may perform blurring and/or enhancement operations on frames of the video stream 208 prior to be sent to the encoder 228. As the video stream 208 may correspond to frames of video and/or frames of game content, whether video or otherwise, the blurring and/or enhancing functionality of the blurring/enhancement operator 224 may occur in real-time or substantially near real-time.

In accordance with examples of the present disclosure, a quality analyzer 240 may be provided that receives an encoded video stream including one or more frames of video or game content. The quality analyzer 240 may decode and analyze a video frame that includes a blurred and/or enhanced area corresponding to the target asset 212. Moreover, the template may be provided by the ROI/NI identifier 220 and/or the template matcher 216 and may be utilized by the quality analyzer 240 to restrict one or more quality analysis techniques to the regions of the frame identified in the mask. Accordingly, an analysis technique, such as but not limited to peak signal to noise ratio (PSNR) or a measured structural similarity index metric (MSSIM) may be utilized to generate a measured quantity indicative of a quality level of the frame and/or a measured quantity indicative of a quality level of one or more regions of interest or regions of non-interest specified by the mask or template. The measured quantity indicative of quality may then be provided as a parameter 236 and may be provided to the blurring/enhancement operator 224 for adjustment and/or control. In at least one example, the blurring/enhancement operator 224 may select a different filtering technique to apply to a frame and/or a region of a frame to increase the resulting quality metric based on the measured quantity indicative of quality. In another example, a bit rate, a resolution, and/or an algorithm utilized by a hardware scaler may be changed and the resulting measured quantity indicative of quality may be received; based on the measured quantity indicative of quality, one or more parameter related to the blurring/enhancement operator 224 and/or the encoder 228 may be adjusted or modified.

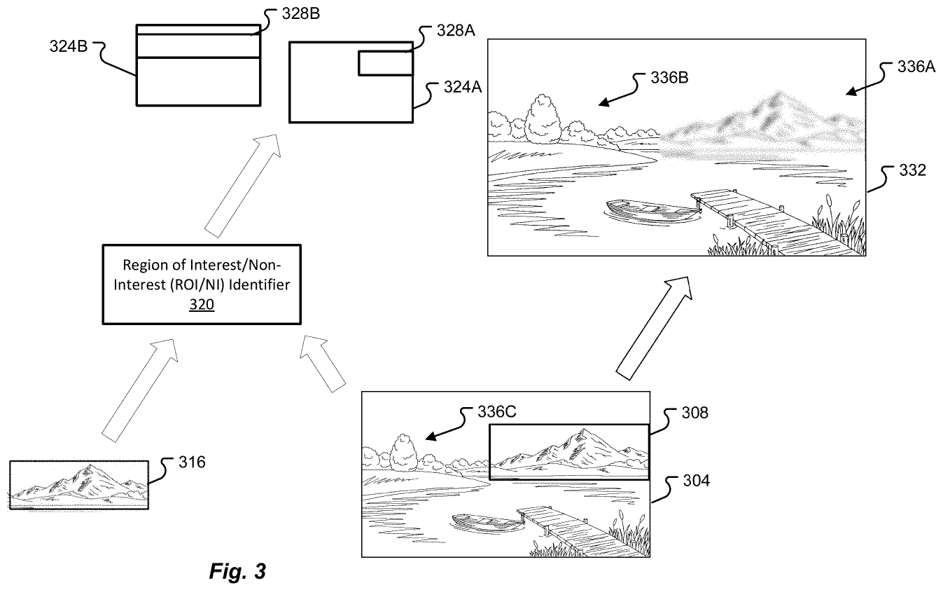

FIG. 3 depicts an example blurring technique applied to a frame of video in accordance with examples of the present disclosure. More specifically, a frame 304, or a portion of a frame 304, corresponding to a frame of video and/or a frame of game content, may be blurred to reduce an amount of data that is needed to describe one or more scenery objects, such as the one or more regions 308 and/or to direct the eyes of a user to a non-blurred region of the frame 304. Accordingly, a target asset 316 corresponding to the one or more regions 308 may be provided to the ROI/NI identifier 320, where the ROI/NI identifier may create a mask 324A corresponding to or otherwise identifying a region of non-interest that is to be blurred. As previously described, a machine learning model, such as the machine learning model 222, may determine one or more regions 308 of the frame 304 corresponding to or otherwise similar to the target asset 316. Accordingly, the ROI/NI identifier 320 may generate a mask 324A that identifies a portion 328A of the frame 304 to be blurred. The blurring/enhancement operator 224 may then blurred the region 336A as depicted in FIG. 3. The resulting frame may then be provided to the encoder, encoded, and transmitted to one or more devices for decoding and subsequent display.

Since the machine learning model may determine one or more regions 308 of the frame 304 corresponding to or otherwise similar to the target asset 316, the ROI/NI identifier 320 may generate a mask 324B that identifies a portion 328B of the frame 304 that may be blurred, since the region 336C of the frame 304 corresponds to a portion of scenery that may be a similar distance from a user as the one or more regions 308. The blurring/enhancement operator 224 may then blurred the region 336A and 336B. The resulting frame may then be provided to the encoder, encoded, and transmitted to one or more devices for decoding and subsequent display.

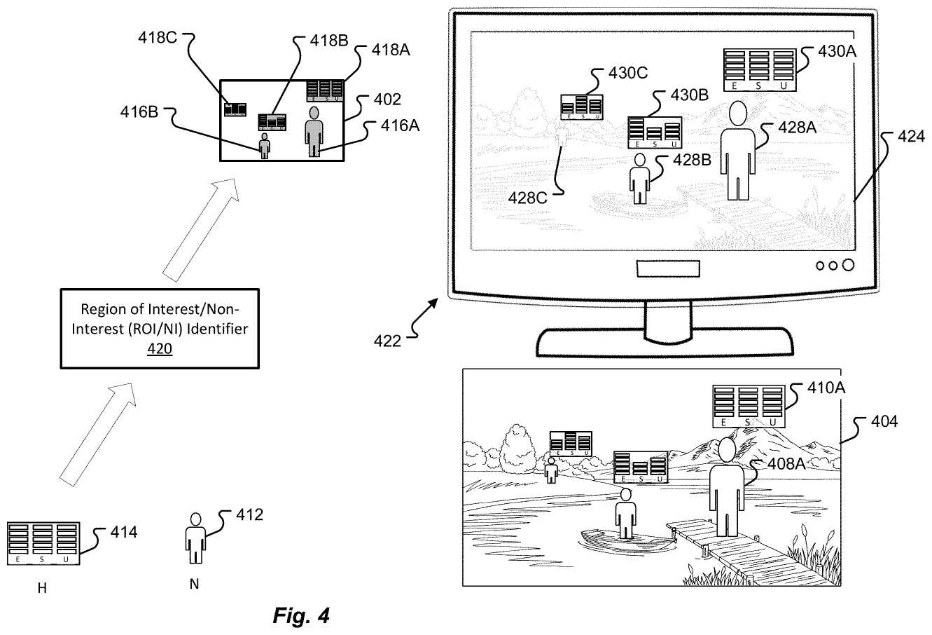

FIG. 4 depicts an example enhancing technique applied to a frame of video in accordance with examples of the present disclosure. More specifically, a frame 404, or a portion of a frame 404, corresponding to a frame of video and/or a frame of game content may be enhanced to distinguish one or more targets in the frame from other regions. That is, a region of interest may be identified and enhanced to provide an additional level of detail, scale, or to direct the eyes of a user to the specified region of interest of the frame 404. Accordingly, one or more target assets, such as a heads up display 414 and a user 412, may be provided to the ROI/NI identifier 420, where the ROI/NI identifier 420 may create a mask 402 corresponding to or otherwise identifying a region of interest that is to be enhanced. For example, the ROI/NI identifier 420 may identify regions of interest 408A and 410A based on the input target assets of 412A and 414A. Accordingly, the mask 402 may include a portion 416A and 418A corresponding to such regions in the frame 404; therefore, the blurring/enhancement operator 224 may enhance the regions of interest 428A and 430A such that regions of interest 428A and 430A stand out or otherwise provide an additional level of detail when compared to other regions of the frame 404. The resulting frame may then be provided to the encoder, encoded, and transmitted to one or more devices for decoding and subsequent display as frame 424, for example at the output device 422.

Moreover, as the heads up display 414 and the user 412 may correspond to other entities in the frame 404, the ROI/NI identifier 420 may identify such entities and account for such entities in the mask 402. For example, although the region of interest 428B associated with the user and the region of interest 430B associated with the heads up display may correspond to a scaled or transformed version of the target assets of the heads up display 414 and the user 412 respectively, the ROI/NI identifier 420 may generate a mask 402 that includes a portion 416B and a portion 418B corresponding to the regions in the frame 404. Therefore, the blurring/enhancement operator 224 may enhance the regions of interest 428B and 430B such that regions of interest 428B and 430B stand out or otherwise provide an additional level of detail when compared to other regions of the frame 404. The resulting frame may then be provided to the encoder, encoded, and transmitted to one or more devices for decoding and subsequent display as frame 424, for example at the output device 422.

In addition, a level of importance may be assigned to each target asset. For example, the target asset of the heads up display 414 may be assigned a level of importance as high or “H” while the target asset of the user 412 is assigned a level of importance as near or “N”. Accordingly, the ROI/NI identifier 420 may identify such entities and account for such entities in the mask 402 in accordance with the level of importance designation. For example, although the region of interest 428C associated with the user and region of interest 430C associated with the heads up display may correspond to a scaled or transformed version of the target assets of the heads up display 414 and the user 412 respectively, the ROI/NI identifier 420 may generate a mask 402 that includes a portion 418B corresponding to one or more regions in the frame 404. Therefore, the blurring/enhancement operator 224 may enhance the region of interest 430C such that region of interest 430C stands out or otherwise provides an additional level of detail when compared to other regions of the frame 404. However, the blurring/enhancement operator 224 may not enhance the region of interest 428C, as the region of interest 428C was determined to correspond to a far or “F” object and therefore does not meet a level of importance threshold for such enhancement. The resulting frame may then be provided to the encoder, encoded, and transmitted to one or more devices for decoding and subsequent display as frame 424, for example at the output device 422.

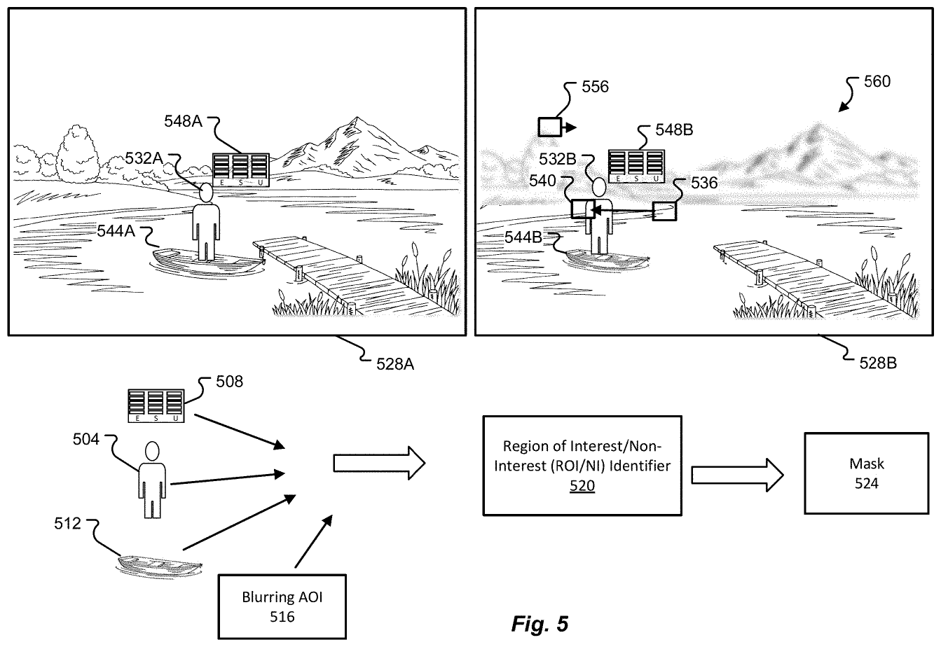

FIG. 5 depicts an example combination of enhancement and blurring techniques applied to a frame of video in accordance with examples of the present disclosure. More specifically, portions of a frame 528A corresponding to a frame of video and/or a frame of game content may be enhanced and blurred to distinguish one or more targets in the frame from other regions of the frame. That is, a region of interest may be identified and enhanced to provide an additional level of detail, scale, or to direct the eyes of a user to the specified region of interest of the frame 528 while a region of non-interest may be identified and blurred to reduce a level of detail, scale, and/or to direct the eyes of a user way from the blurred region of interest of the frame 528. Accordingly, one or more target assets, such as a user 504, a heads up display 508, and a boat 512 may be provided to the ROI/NI identifier 520, where the ROI/NI identifier 520 may create a mask 524 corresponding to or otherwise identifying regions of interest that are to be enhanced and regions of non-interest that are to be blurred. For example, the ROI/NI identifier 520 may identify regions of interest 532A 544A and 548A based on the input target assets of 504, 508, and 512. Accordingly, the mask 524 may include portions corresponding to such regions in the frame 528A; therefore, the blurring/enhancement operator 224 may enhance the regions of interest 532A, 544A, and 548A such that these regions stand out or otherwise provide an additional level of detail when compared to other regions of the frame. The resulting frame may then be provided to the encoder, encoded, and transmitted to one or more devices for decoding and subsequent display at an output device.

In accordance with aspects of the present disclosure, a target asset 516 may correspond to one or more models and/or parameters specifying that one or more features of the frame 528B matching or corresponding to the model should be blurred or enhanced. For example, the target asset 516 may specify that scenery objects in the background appearing to be more than a specific distance from a user should be blurred if bits need to be conserved. Accordingly, the background 560 in the frame 528B may be blurred. As another example, the target asset 516 may specify that objects moving from a first location to a second location at a speed slower than a threshold should be blurred while object moving from a first location to a second location at a speed greater than a threshold should be enhanced, or vice versa. Accordingly, one or more motion vectors may be identified for an object, such as object 556; as the motion vector for the object 556 indicates that the object moves slowly, the object 556 may be blurred. Additionally, one or more motion vectors may be identified for the object 536 corresponding to a portion of the displayed user object 532B. As the portion of the displayed user object 532B moved from a first location (in 528A) to a second location (in 528B), the object 536 and/or 540 may have moved quickly such that the object 536 or 540 is enhanced. Similarly, objects 544B and 532B may be enhanced because such objects are moving in the foreground and/or have been determined to display information of a high level of importance. The resulting frame may then be provided to the encoder, encoded, and transmitted to one or more devices for decoding and subsequent display at an output device.

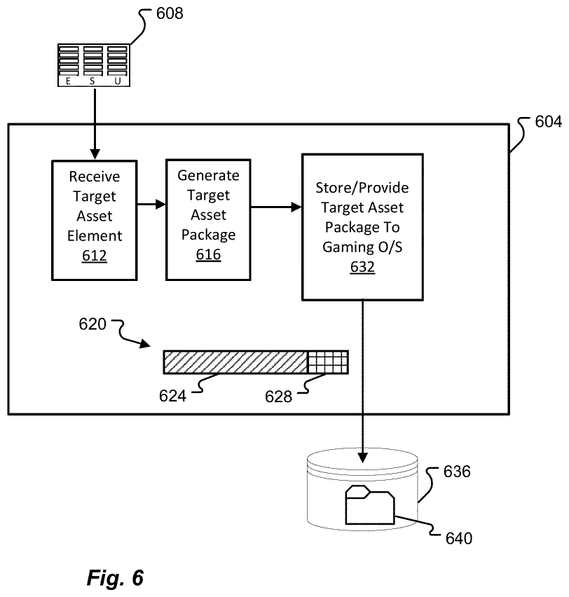

FIG. 6 depicts details of a block diagram directed to one or more tools for generating a target asset model and/or a target asset package in accordance with examples of the present disclosure. More specifically, the developer tool 604 may reside at a developer client device, such as any of the previously described client devices 116A-116D. A target asset 608 may be provided to the developer tool 604 and received at 612; as depicted in FIG. 6, the target asset 608 may correspond to or otherwise be associated with a heads up display. The developer tool 604 may generate a target asset package 620 at 616, where the target asset package 620 may include a data portion 624 and a metadata portion 628. The data portion 624 may correspond to a representation of the target asset 608 in a machine readable form. For example, the data portion 624 may describe the target asset package 620 in one or more formats optimized for matching and/or to be input to the machine learning model 222; such formats may include, but are not limited to a scalable vector format, a grayscale format, an edge enhanced format, a matrix format, an image pyramid format, a singular value decomposition format, a discrete cosign transformation format, a wavelet format, etc. . . . . In addition, characteristics and/or parameters describing the data portion 624 may be stored in the metadata portion 628. The metadata portion 628 may include information such as, but not limited target asset description, target asset importance level, one or more blurring and/or enhancement effects to be applied, whether or not the such blurring and/or enhancements are triggered based on another object being present etc. . . . . Accordingly, at 632, the developer tool 604 may store the target asset package 620 at a storage location 636 as a target asset package file 640. The storage location 636 may correspond to a database or other storage location that may be accessible by a game or title.

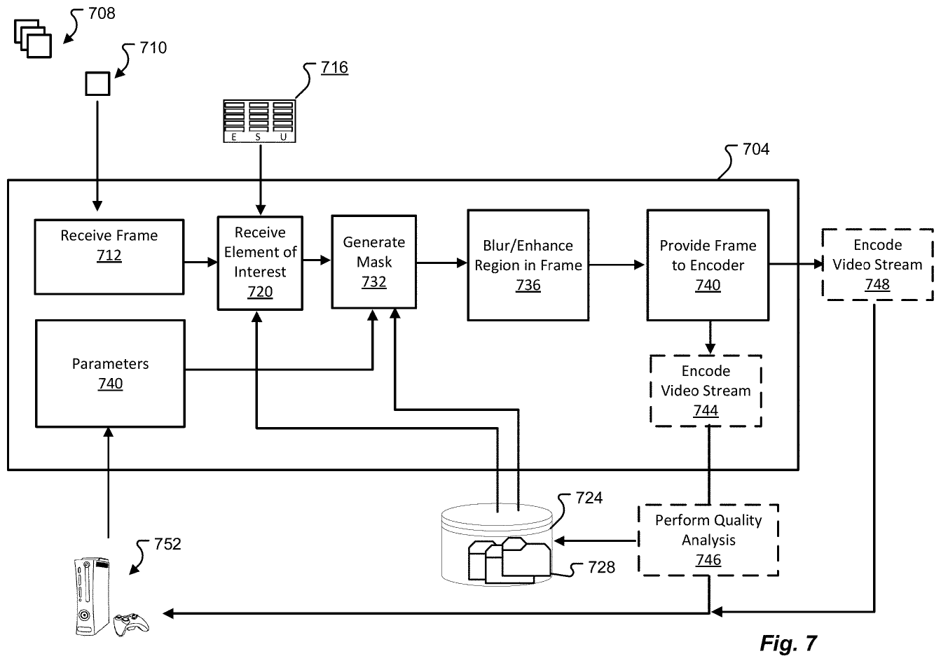

FIG. 7 depicts details of a block diagram directed to a processor for enhancing a region of interest and/or blurring a region of non-interest in accordance with examples of the present disclosure. More specifically, video content, such as video content associated with a game, may be provided to the pre-encoder frame analyzer 704, where the pre-encoder frame analyzer 704 may be the same as or similar to the pre-encoder frame analyzer 204. The pre-encoder frame analyzer 704 may receive a frame 710, or a plurality of frames 708 associated with video content, at 712. At 720, the target asset 716 may be received. The target asset 716 may correspond to an image or description of an image that is to be blurred or enhanced; in some instances, the target asset 716 may correspond to an image, portion of an image, or a description of an image to which one or more operations may be performed. As depicted in FIG. 7, the target asset 716 corresponds to a heads up display. In some instances, a database or storage location 724 including a plurality of target assets 728 may supply the one or more target assets 716 to the pre-encoder frame analyzer 704. For example, the pre-encoder frame analyzer 704 may generate one or more masks to blur or enhance content based associated with a plurality of target assets 728, where a subset of the target assets 728 may be in any given frame of video content. Accordingly, in a first frame, only one target asset may be present in the frame while in a second frame four target assets may be available. That is, one or more target assets may be blurred, enhanced, or otherwise operated upon based on a bit rate budget for an encoded frame and/or a quality of a resulting encoded frame.

The pre-encoder frame analyzer 704 may then generate a mask at 732 utilizing one or more machine learning models, such as the machine learning model 222 previously described. The mask may correspond to a single target asset; alternatively, or in addition, the mask may correspond to a plurality of target assets. That is, the mask that is generated by the pre-encoder frame analyzer 704 may include regions of interest or regions of non-interest corresponding to multiple target assets. In some instances, the mask may be specific to one or more parameters 740 received from or otherwise corresponding to transmission characteristics between a device 752, such as a console, and one or more game servers. In some instances, the mask may be specific to one or more parameters 740 indicating one or more characteristics of the device 752. In some instances, the mask may be based on a quality analysis of a previously encoded frame. Moreover, the mask generated at 732 may include information indicating what operation is to be performed for each region of interest or region of non-interest identified in the mask as well respective operation parameters, such as but not limited to a strength of a blur operation, a strength of a contrast operation, a level of hue change etc. . . . . At 736, the pre-encoder frame analyzer 704 may perform some operation on one or more regions of interest or regions of non-interest indicated or otherwise identified by the mask. As previously discussed, one or more regions of interest or regions of non-interest may indicate the operation and operation characteristics that are to be performed at 736. The resulting frame may then be provided to the encoder at 740, where the encoding operations 744 and/or 748 may occur within and/or outside of the pre-encoder frame analyzer 704.

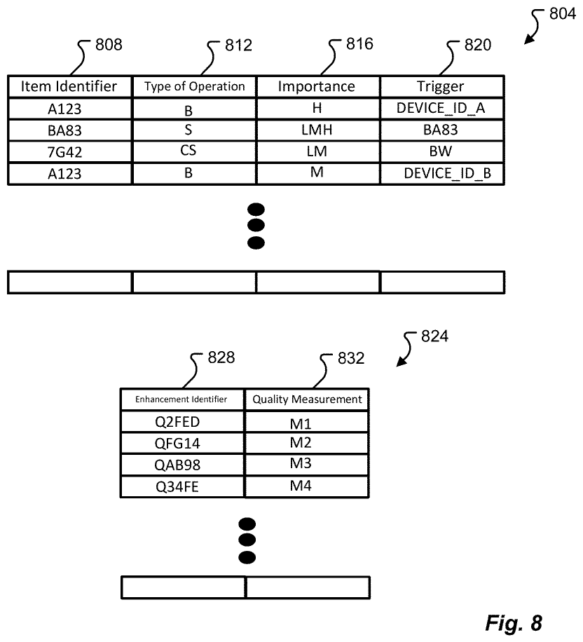

FIG. 8 describes additional details of a first data structure associated with a target asset package and a second data structure associated with a quality level measurement in accordance with examples of the present disclosure. More specifically, the first data structure 804 may correspond to or otherwise be associated with one or more target assets, and more specifically, a target asset package such as the target asset package file 640 or the plurality of target assets 728. The first data structure 804 may include an item identifier 808 specifically identifying the target asset and/or target asset package. The first data structure may identify the type of operation 812 to be performed. For example, a blur operation may occur for a first target asset while a contrast and sharpen operation may occur for a third target asset. The first data structure 804 may also associate an importance indication 816 with each target asset. For example, a blur operation of the first target asset may be a high priority operation such that a mask having a blur feature is generated a high percentage of the time for frames including the first target asset. As an alternative, the contrast and sharpen operation may be designated a low to medium priority such that a mask having a contrast and sharpen feature is generated for a much lower percentage of the time for frames including the third target asset. In addition, the first data structure may indicate an operation trigger 820; that is, the operation trigger may indicate what, if any, thresholds, parameters, or otherwise are to be present to trigger the specific operation for the specified target asset. For example, a blur operation for a specific target asset may be designate a high level of priority for a specific device. For the same specific target asset, a blur operation may be specified as a medium level of priority for a different device.

FIG. 8 also depicts a data structure 824 providing quality measurement information for a specific enhancement identifier. More specifically, the enhancement identifier 828 may correspond to a specific item identifier 808, or may correspond to a group of item identifiers 808. That is, the resulting quality measurement 832 may be for a group of operations that have been applied to a frame or a single operation that has been applied to the frame. Such information may be stored in the data structure 824 such that the ROI/NI and/or the blurring/enhancement operator 224 for example, may adjust or modify one or more of the masks and/or operations to achieve a desirable quality measurement.

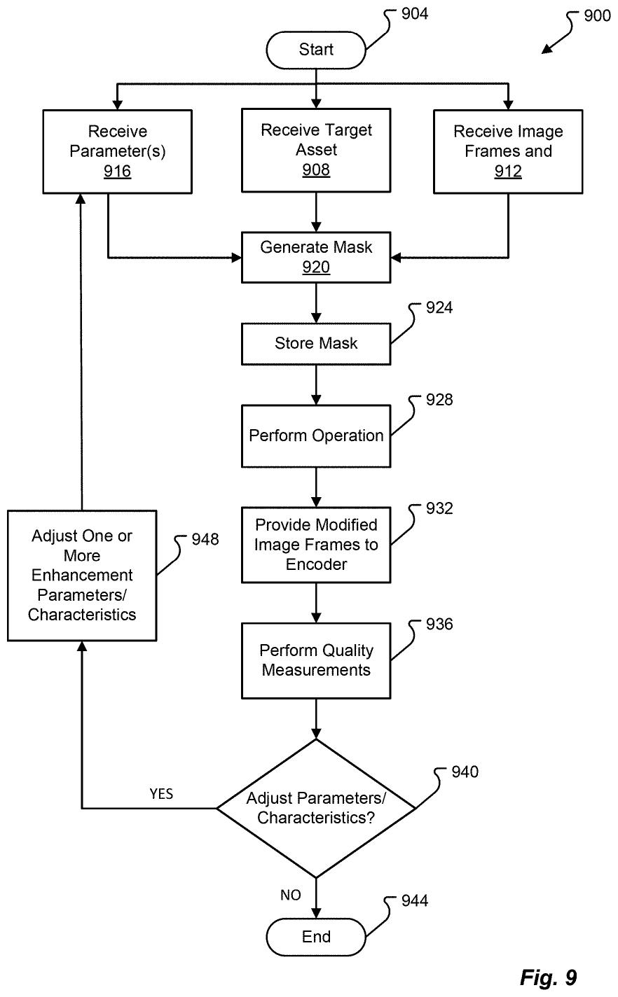

FIG. 9 depicts details of a method 900 for generating a mask, performing an operation based on the mask, and further performing a frame quality analysis in accordance with examples of the present disclosure. A general order for the steps of the method 900 is shown in FIG. 9. Generally, the method 900 starts with a start operation 904 and ends with the end operation 944. The method 900 may include more or fewer steps or may arrange the order of the steps differently than those shown in FIG. 9. The method 900 may be executed as a set of computer-executable instructions executed by a computer system and encoded or stored on a computer readable medium. Further, the method 900 may be performed by gates or circuits associated with a processor, Application Specific Integrated Circuit (ASIC), a field programmable gate array (FPGA), a system on chip (SOC), or other hardware device. Hereinafter, the method 900 shall be explained with reference to the systems, components, modules, software, data structures, user interfaces, etc. described in conjunction with FIGS. 1-8.

The method 900 starts at 904 and proceeds to steps 908, 912, and 916, where a target asset may be received. The target asset may be received directly as an image. Alternatively, or in addition, the target asset may be received as a target asset package as previously described. That is, the target asset may be received as a processed image or otherwise processed data file including information about the target asset and instances when an operation should be applied to the target asset. For example, a data file including a representation of the target asset may be received, where the data file further indicates that a blurring operation is to be performed for all regions of non-interest similar to or otherwise associated with the target asset. That is, if the target asset is scenery, other background scenery may be blurred. At 912, one or more frames of video content, for example corresponding to game content, is received. At 916 one or more parameters influencing the mask generation and/or the operations to be applied to be applied to the target assets may be received. For example, a bit rate for the encoder and/or a quality measurement may be received. Based on the target asset, the received parameters, and the one or more frames of video content, the method may proceed to 920 where the mask may be generated for one or more specific frames of content received at 912. In some instances, a machine learning model, such as the machine learning model 222 may be utilized to generate the mask and/or determine which operation and which target assets should be blurred and/or enhanced. Accordingly, the generated mask may be stored at 924.

The method 900 may proceed to 928, where one or more operations may be performed on the one or more frames received at 912 based on the mask. For example, the blurring/enhancement operator 224 may perform a blurring operation and/or an enhancement operation at 928. The modified frames, which are the frames subjected to the one or more operations, may be provided to an encoder at 932 such that the encoder may encode the modified frames. After 932, the encoded frames may be provided to a client device as previously discussed. The method may proceed to 936 where a quality analysis measurement may be performed on one or more encoded frames. In some instances, quality measurements may be performed randomly or according to a set schedule for instance. At 940, based on the quality measurements, the method may determine whether one or more parameters may need to be adjusted. For example, if the measured quality is less than a threshold, the method may proceed from 940 to 948, where one or more parameters may be adjusted. If however, the quality is greater than or equal to a threshold, the method 900 may end at 944.

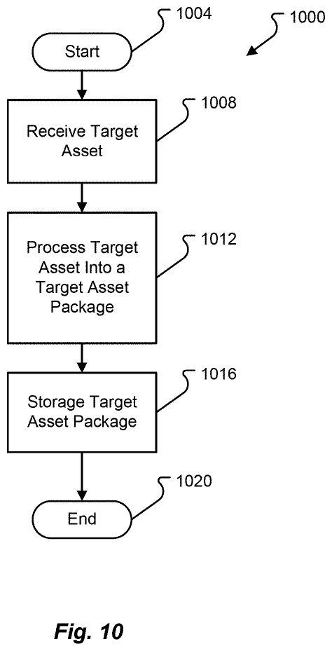

FIG. 10 depicts details of a method 1000 for generating a target asset package utilizing one or more developer tools in accordance with examples of the present disclosure. A general order for the steps of the method 1000 is shown in FIG. 10. Generally, the method 1000 starts with a start operation 1004 and ends with the end operation 1020. The method 1000 may include more or fewer steps or may arrange the order of the steps differently than those shown in FIG. 10. The method 1000 may be executed as a set of computer-executable instructions executed by a computer system and encoded or stored on a computer readable medium. Further, the method 1000 may be performed by gates or circuits associated with a processor, Application Specific Integrated Circuit (ASIC), a field programmable gate array (FPGA), a system on chip (SOC), or other hardware device. Hereinafter, the method 1000 shall be explained with reference to the systems, components, modules, software, data structures, user interfaces, etc. described in conjunction with FIGS. 1-9.

The method 1000 starts at 1004 and proceeds to step 1008, where a target asset may be received. More specifically, a developer may provide a target asset and/or a machine learning model may identify one or more target assets upon analyzing one or more frames of video. For example, a machine learning model may identify one or more target assets that should be blurred and/or enhanced based on a determination that an entity in a frame of video is far from a user, provides relevant information to a user, and/or should draw a user's attention to or away from a specific area of a display. Accordingly, the target asset may be processed at 1012 into one or more target asset packages. As previously discussed, the target asset package may include a data portion associated with the target asset itself and may further include a metadata portion indicating one or more parameters that may need to be triggered for the target asset and associated target asset characteristics to be implemented at a blurring/enhancement operator. At 1016, the target asset package may be stored in an area accessible to a pre-encoder frame analyzer. The method 1000 may end at 1020.

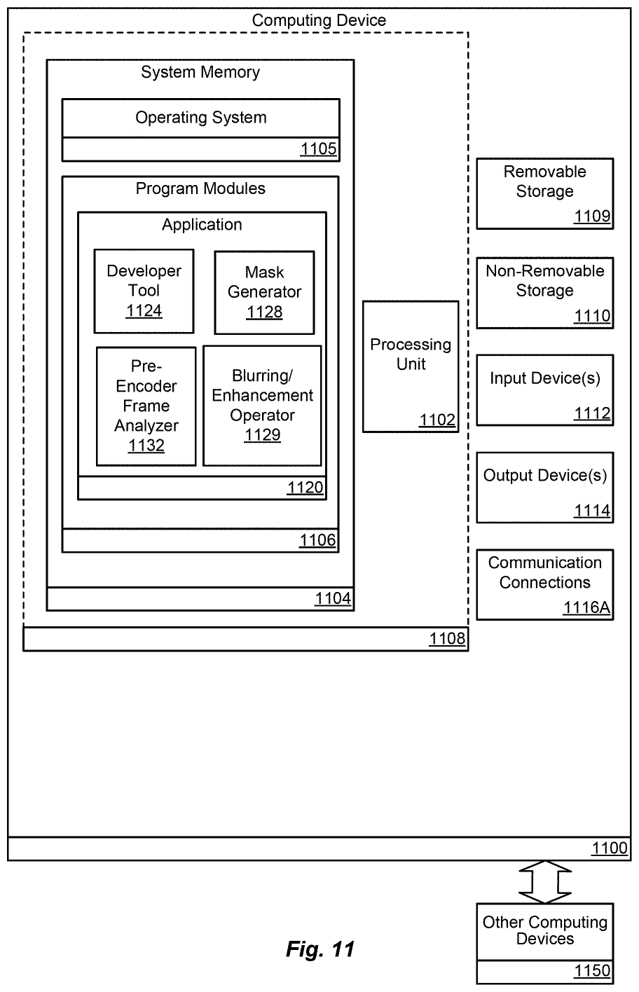

FIG. 11 is a block diagram illustrating physical components (e.g., hardware) of a computing device 1100 with which aspects of the disclosure may be practiced. The computing device components described below may be suitable for the computing devices, such as the client device 116, and/or the interface component 108, as described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for performing the various aspects disclosed herein such as the developer tool 1124, the pre-encoder frame analyzer 1132, the mask generator 1128, and/or the blurring/enhancement operator 1129. The operating system 1105, for example, may be suitable for controlling the operation of the computing device 1100. The operating system 1105, for example, may be suitable for controlling game and/or title execution and/or generating a video stream including game content. Furthermore, aspects of the disclosure may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., one or more applications 1120) may perform processes including, but not limited to, the aspects as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, etc. The output device(s) 114 such as a display, speakers, a printer, etc. may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

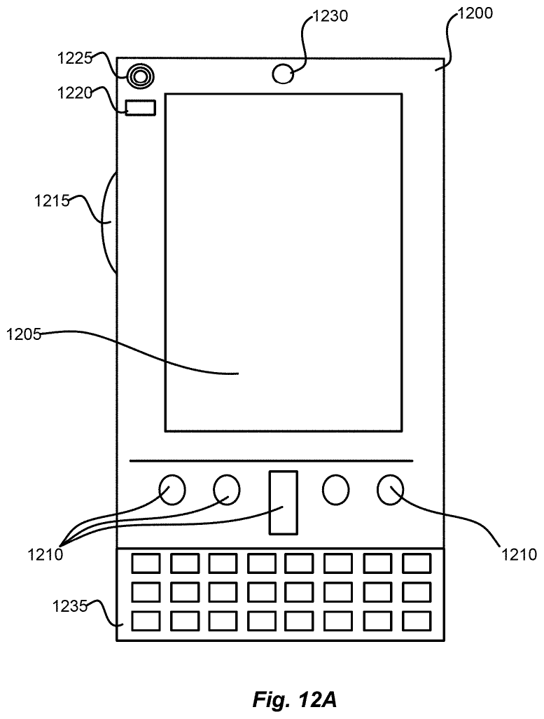

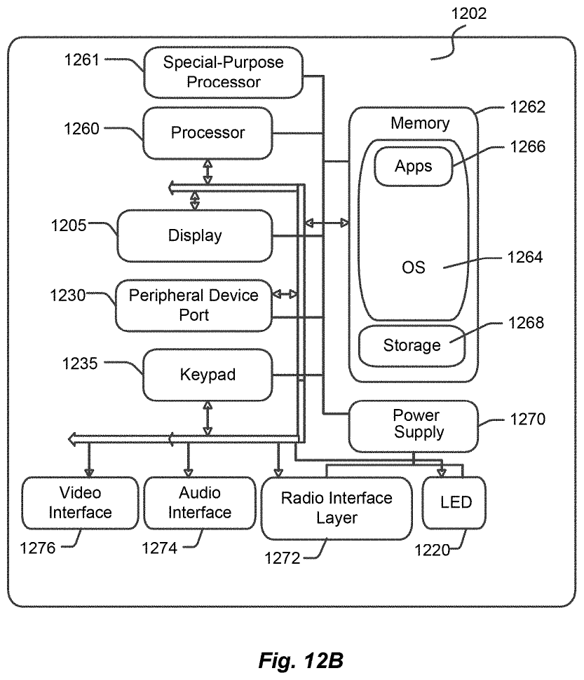

FIGS. 12A and 12B illustrate a computing device, client device, or mobile computing device 1200, for example, a mobile telephone, a smart phone, wearable computer (such as a smart watch), a tablet computer, a laptop computer, and the like, with which aspects of the disclosure may be practiced. In some aspects, the client device (e.g., 116A-116D) may be a mobile computing device. With reference to FIG. 12A, one aspect of a mobile computing device 1200 for implementing the aspects is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative aspects, mobile computing device 1200 may incorporate more or less input elements. For example, the display 1205 may not be a touch screen in some aspects. In yet another alternative aspect, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various aspects, the output elements include the display 1205 for showing a graphical user interface (GUI), a visual indicator 1220 (e.g., a light emitting diode), and/or an audio transducer 1225 (e.g., a speaker). In some aspects, the mobile computing device 1200 incorporates a vibration transducer for providing the user with tactile feedback. In yet another aspect, the mobile computing device 1200 incorporates input and/or output ports, such as an audio input (e.g., a microphone jack), an audio output (e.g., a headphone jack), and a video output (e.g., a HDMI port) for sending signals to or receiving signals from an external source.

FIG. 12B is a block diagram illustrating the architecture of one aspect of computing device, a server (e.g., game server 104A-104D), or a mobile computing device (e.g., client device 116A-D). That is, the computing device 1200 can incorporate a system (e.g., an architecture) 1202 to implement some aspects. The system 1202 can implemented as a “smart phone” capable of running one or more applications (e.g., browser, e-mail, calendaring, contact managers, messaging clients, games, and media clients/players, gaming applications). In some aspects, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, gaming programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, title content, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200 described herein (e.g., gaming platform, pre-encoder frame analyzer, mask generator, etc.).

The system 1202 has a power supply 1270, which may be implemented as one or more batteries. The power supply 1270 might further include an external power source, such as an AC adapter or a powered docking cradle that supplements or recharges the batteries.

The system 1202 may also include a radio interface layer 1272 that performs the function of transmitting and receiving radio frequency communications. The radio interface layer 1272 facilitates wireless connectivity between the system 1202 and the “outside world,” via a communications carrier or service provider. Transmissions to and from the radio interface layer 1272 are conducted under control of the operating system 1264. In other words, communications received by the radio interface layer 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated configuration, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with aspects of the present disclosure, the microphone may also serve as an audio sensor to facilitate control of notifications, as will be described below. The system 1202 may further include a video interface 1276 that enables an operation of an on-board camera 1230 to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 12B by the non-volatile storage area 1068.

Data/information generated or captured by the mobile computing device 1200 and stored via the system 1202 may be stored locally on the mobile computing device 1200, as described above, or the data may be stored on any number of storage media that may be accessed by the device via the radio interface layer 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio interface layer 1272 or via a distributed computing network. Similarly, such data/information may be readily transferred between computing devices for storage and use according to well-known data/information transfer and storage means, including electronic mail and collaborative data/information sharing systems.

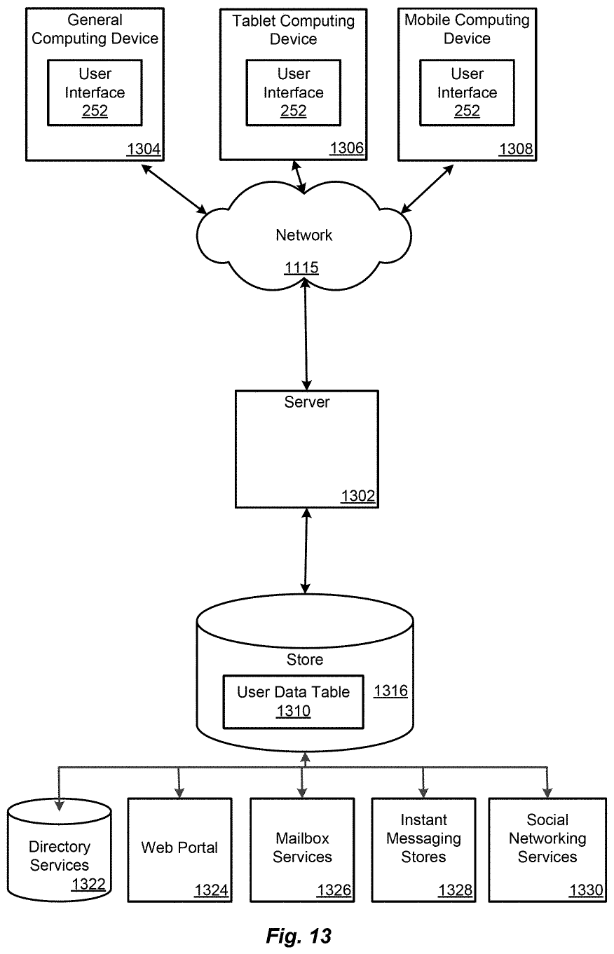

FIG. 13 illustrates one aspect of the architecture of a system for processing data and/or video received at a server device 1302 (e.g., interface component 108) from a remote source, as described above. Content at a server device 1302 may be stored in different communication channels or other storage types. For example, various game/title images, one or more video frames including game content, images, or files may be stored using a directory service 1322, a web portal 1324, a mailbox service 1326, an instant messaging store 1328, or a social networking site 1330. A unified profile API based on the user data table 1310 may be employed by a client that communicates with server device 1302, and/or the content generator may be employed by server device 1302. The server device 1302 may provide data to and from a client computing device such as the client devices 116A-116D through a network 1315. By way of example, the client device 116 described above may be embodied in a personal computer 1304, a tablet computing device 1306, and/or a mobile computing device 1308 (e.g., a smart phone). Any of these configurations of the computing devices may obtain video content, such as one or more frames of video corresponding to game content, images, or files from the store 1316, in addition to receiving graphical data useable to be either pre-processed at a graphic-originating system, or post-processed at a receiving computing system.

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infrared data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In accordance with at least one example of the present disclosure, a system to modify a visual quality of an area within a frame of video is provided. The system may include least one processor and at least one memory including instructions which when executed by the at least one processor, causes the at least one processor to receive one or more video frames of a video stream, receive a target asset and generate a frame mask identifying an area within the one or more video frames of the video stream that is associated with the target asset, and modify a visual quality of the identified area within the one or more video frames based on the frame mask.

Further, at least one aspect of the above example includes where the one or more instructions causes the at least one processor to utilize a machine learning model to generate the frame mask based on the received target asset and one or more parameters associated with an encoder bit rate. Further, at least one aspect of the above example includes where the one or more instructions causes the at least one processor to utilize a machine learning model to analyze the one or more video frames, identify the target asset from the one or more video frames, and generate the frame mask identifying the area within the one or more video frames that is associated with the target asset based on the machine learning analysis. Further yet, at least one aspect of the above example includes where the one or more instructions causes the at least one processor to utilize a machine learning model to generate the frame mask identifying a plurality of separate areas within the one or more video frames of the video stream that are associated with the target asset. Further still, at least one aspect of the above example includes where the plurality of separate areas within the one or more video frames of the video stream are associated with a scaled, transformed, and/or rotated version of the target asset. Further, at least one aspect of the above example includes where the frame mask specifies that a different visual quality associated with the identified separate areas is modified. Further yet, at least one aspect of the above example includes where the target asset is received as a target asset package, the target asset package including a data portion corresponding to the target asset and a metadata portion including parameters for modifying the visual quality of the identified area within the one or more video frames based on the frame mask. Further, at least one aspect of the above example includes where the one or more instructions causes the at least one processor to modify the visual quality of the identified area within the one or more video frames by performing one or more of a blurring operation or an enhancement operation. Further yet, at least one aspect of the above example includes where the one or more instructions causes the at least one processor to: generate a measure of quality for an encoded video frame corresponding to the one or more video frames having a modified visual quality, and adjust at least one operation performed on the identified area within the one or more video frames based on the measure of quality. Further still, at least one aspect of the above example includes where the one or more instructions causes the at least one processor to encode the one or more video frames subsequent to the visual quality of the identified area within the one or more video frames having been modified.

In accordance with at least one example of the present disclosure, a method for modifying a visual quality of an area of interest within a frame of video is provided. The method may include receiving one or more video frames of a video stream, receiving a target asset, matching the target asset to one or more areas within the one or more video frames, generating a frame mask identifying the one or more areas within the one or more video frames, the frame mask including one or more parameters for modifying a visual quality of the one or more areas within the one or more video frames, modifying the visual quality of the one or more areas within the one or more video frames based on the frame mask thereby generating one or more modified video frames, encoding the one or more modified video frames, generating a measure of quality for the one or more encoded video frames, and adjusting at least one parameter associated with the frame mask based on the measure of quality.

At least one aspect of the above example includes where the at least one parameter is based on a display device to which the one or more encoded video frames of the video stream are transmitted. Further still, at least one aspect of the above example includes utilizing a machine learning model to generate the frame mask based on the received target asset and one or more parameters associated with an encoder bit rate. Further, at least one aspect of the above example includes utilizing a machine learning model to analyze the one or more video frames, identifying the target asset from the one or more video frames, and generating the frame mask identifying the one or more areas within the one or more video frames based on the machine learning analysis. Further yet, at least one aspect of the above example includes utilizing a machine learning model to generate the frame mask identifying a plurality of separate areas within the one or more video frames of the video stream. Further still, at least one aspect of the above example includes where the plurality of separate areas within the one or more video frames of the video stream are associated with a scaled, transformed, and/or rotated version of the target asset. Further yet, at least one aspect of the above example includes receiving the target asset as a target asset package, the target asset package including a data portion corresponding to the target asset and a metadata portion including parameters for modifying the visual quality of the one or more identified areas within the one or more video frames.

In accordance with at least one example of the present disclosure, a computer storage media is provided. The computer storage media may include instructions which when executed by a computer, perform a method for modifying a visual quality of an area within a frame of video. The method may include receiving one or more video frames of a video stream, utilizing a machine learning model to: analyze the one or more video frames, identify a target asset from the one or more video frames, and generate a frame mask identifying an area within the one or more video frames that is associated with the target asset; and modifying a visual quality of the identified area within the one or more video frames based on the frame mask.

At least one aspect of the above example includes performing one or more of a blurring operation or an enhancement operation to modify the visual quality of the identified area within the one or more video frames. Further still, at least one aspect of the above example includes generating a measure of quality for an encoded video frame corresponding to the one or more video frames having a modified visual quality, and adjusting at least one of the blurring operation or the enhancement operation based on the measure of quality.

Any one or more of the aspects as substantially disclosed herein.

Any one or more of the aspects as substantially disclosed herein optionally in combination with any one or more other aspects as substantially disclosed herein.

One or means adapted to perform any one or more of the above aspects as substantially disclosed herein.

What is claimed is:

1. A system to modify a visual quality of an area within a frame of video, the system comprising:
at least one processor; and
at least one memory including instructions which when executed by the at least one processor, causes the at least one processor to:
receive one or more video frames of a video stream,
receive a target asset and generate a frame mask identifying an area within the one or more video frames of the video stream that is associated with the target asset, and
modify a visual quality of the identified area within the one or more video frames based on the frame mask.

2. The system of claim 1, wherein the one or more instructions causes the at least one processor to utilize a machine learning model to generate the frame mask based on the received target asset and one or more parameters associated with an encoder bit rate.

3. The system of claim 1, wherein the one or more instructions causes the at least one processor to utilize a machine learning model to analyze the one or more video frames, identify the target asset from the one or more video frames, and generate the frame mask identifying the area within the one or more video frames that is associated with the target asset based on the machine learning analysis.

4. The system of claim 1, wherein the one or more instructions causes the at least one processor to utilize a machine learning model to generate the frame mask identifying a plurality of separate areas within the one or more video frames of the video stream that are associated with the target asset.

5. The system of claim 4, wherein the plurality of separate areas within the one or more video frames of the video stream are associated with a scaled, transformed, and/or rotated version of the target asset.

6. The system of claim 4, wherein the frame mask specifies that a different visual quality associated with the identified separate areas is modified.

7. The system of claim 1, wherein the target asset is received as a target asset package, the target asset package including a data portion corresponding to the target asset and a metadata portion including parameters for modifying the visual quality of the identified area within the one or more video frames based on the frame mask.

8. The system of claim 1, wherein the one or more instructions causes the at least one processor to modify the visual quality of the identified area within the one or more video frames by performing one or more of a blurring operation or an enhancement operation.

9. The system of claim 1, wherein the one or more instructions causes the at least one processor to:
generate a measure of quality for an encoded video frame corresponding to the one or more video frames having a modified visual quality, and
adjust at least one operation performed on the identified area within the one or more video frames based on the measure of quality.

10. The system of claim 1, wherein the one or more instructions causes the at least one processor to encode the one or more video frames subsequent to the visual quality of the identified area within the one or more video frames having been modified.

11. A method for modifying a visual quality of an area of interest within a frame of video, the method comprising:
receiving one or more video frames of a video stream;
receiving a target asset;
matching the target asset to one or more areas within the one or more video frames;
generating a frame mask identifying the one or more areas within the one or more video frames, the frame mask including one or more parameters for modifying a visual quality of the one or more areas within the one or more video frames;
modifying the visual quality of the one or more areas within the one or more video frames based on the frame mask thereby generating one or more modified video frames;
encoding the one or more modified video frames;
generating a measure of quality for the one or more encoded video frames; and
adjusting at least one parameter associated with the frame mask based on the measure of quality.

12. The method of claim 11, wherein the at least one parameter is based on a display device to which the one or more encoded video frames of the video stream are transmitted.

13. The method of claim 11, further comprising utilizing a machine learning model to generate the frame mask based on the received target asset and one or more parameters associated with an encoder bit rate.

14. The method of claim 11, further comprising:
utilizing a machine learning model to analyze the one or more video frames;
identifying the target asset from the one or more video frames, and
generating the frame mask identifying the one or more areas within the one or more video frames based on the machine learning analysis.

15. The method of claim 11, further comprising utilizing a machine learning model to generate the frame mask identifying a plurality of separate areas within the one or more video frames of the video stream.

16. The method of claim 15, wherein the plurality of separate areas within the one or more video frames of the video stream are associated with a scaled, transformed, and/or rotated version of the target asset.

17. The method of claim 15, further comprising: receiving the target asset as a target asset package, the target asset package including a data portion corresponding to the target asset and a metadata portion including parameters for modifying the visual quality of the one or more identified areas within the one or more video frames.

18. A computer storage media containing computer executable instruction, which when executed by a computer, perform a method for modifying a visual quality of an area within a frame of video, the method comprising:
receiving one or more video frames of a video stream,
utilizing a machine learning model to:
analyze the one or more video frames,
identify a target asset from the one or more video frames, and
generate a frame mask identifying an area within the one or more video frames that is associated with the target asset; and
modifying a visual quality of the identified area within the one or more video frames based on the frame mask.

19. The method of claim 18, further comprising performing one or more of a blurring operation or an enhancement operation to modify the visual quality of the identified area within the one or more video frames.

20. The method of claim 19, further comprising:
generating a measure of quality for an encoded video frame corresponding to the one or more video frames having a modified visual quality, and
adjusting at least one of the blurring operation or the enhancement operation based on the measure of quality.
